(19) United States
(12) Patent Application Publication
(10) Pub. No.: US 2015/0193053 A1
(43) Pub. Date: Jul. 9, 2015

(54) INPUT DEVICE

(71) Applicant: Panasonic Intellectual Property Management Co., Ltd., Osaka (JP)

(72) Inventors: Kazushige TAKAGI, Osaka (JP); Manabu INOUE, Osaka (JP); Naoki KOSUGI, Kyoto (JP); Takahito NAKAYAMA, Osaka (JP); Akira TOKAI, Hyogo (JP); Shigeo KASAHARA, Hyogo (JP); Hiroyuki KADO, Osaka (JP); Shuji INOUE, Osaka (JP); Toshiyuki AOYAMA, Osaka (JP)

(21) Appl. No.: 14/660,522

(22) Filed: Mar. 17, 2015

Related U.S. Application Data
(63) Continuation of application No. PCT/JP2013/005893, filed on Oct. 3, 2013.

(30) Foreign Application Priority Data
Mar. 4, 2013 (JP) 2013-041521

(51) Int. Cl. G06F 3/044

(52) U.S. Cl. CPC G06F 3/044; G06F 2203/04112

(57) ABSTRACT

An input device according to the present disclosure is an input device arranged in a display device that sequentially applies a scanning signal to a plurality of scanning signal lines in one frame period to perform update of display, the input device comprising driving electrodes in quantity of N provided corresponding to the plurality of scanning signal lines, and a plurality of sensing electrodes arranged so as to intersect with the driving electrodes in quantity of N to form capacitive elements at intersection portions. In a touch detection period, a driving signal is sequentially applied to the driving electrodes in quantity of N, and a touch detection is performed based on a detection signal output from each of the plurality of sensing electrodes.

### BACKGROUND

1. Field

The present disclosure relates to a capacitive coupling type input device that inputs coordinates to a screen.

2. Description of the Related Art

A display device including an input device having a screen input function of inputting information to a display screen by performing touch operation with a finger or the like of a user is used for a mobile electronic instrument such as a PDA (Personal Digital Assistant) and a portable terminal, various household electric appliances, and a stationary customer guiding terminal such as an unmanned reception machine. As the above-described input device by touching, there have been known a resistive film type that detects resistance value change at a touched portion, a capacitive coupling type that detects capacitance change, an optical sensor type that detects light quantity change at a portion blocked off by touching, and the like.

The capacitive coupling type has the following advantages, as compared with the resistive film type and the optical sensor type. For example, the resistive film type and the optical sensor type each have a lower transmittance of about 80%, while the capacitive coupling type has a higher transmittance of about 90%, which does not deteriorate display image quality. Moreover, since in the resistive film type, a touch position is sensed by mechanical contact with a resistive film, there is a possibility of degrading or damaging the resistive film. In contrast, in the capacitive coupling type, there is no mechanical contact such as contact of an electrode for detection with another electrode or the like, which is advantageous in durability as well.

As the capacitive coupling type input device, there is a system disclosed, for example, in Unexamined Japanese Patent Publication No. 2011-90458.

### SUMMARY

An input device according to the present disclosure is an input device arranged in a display device that sequentially applies a scanning signal to a plurality of scanning signal lines in one frame period to perform update of display, the input device having driving electrodes in quantity of N provided corresponding to the plurality of scanning signal lines, and a plurality of sensing electrodes arranged so as to intersect with the driving electrodes to form capacitive elements at intersection portions. The input device is configured such that in a touch detection period, a driving signal is sequentially applied to the driving electrodes in quantity of N, and a touch detection is performed based on a detection signal output from each of the plurality of sensing electrodes, and the scanning signal is input to the scanning signal lines at a timing of Ts, then an input operation of the driving signal to the driving electrodes in quantity of N is configured such that the input of the driving signal starts from an Nx-th (a numerical value obtained by adding an integer of one or more to a first driving electrode) driving electrode at input timing Ty (a numerical value obtained by adding an integer of 0 or more to Ts), and one of the driving electrodes that does not correspond to the scanning signal lines to which the scanning signal is being input is selected to input the driving signal.

### BRIEF DESCRIPTION OF DRAWINGS

FIG. 1 is a block diagram for describing an entire configuration of a liquid crystal display device having a touch sensor function according to one exemplary embodiment of the present disclosure;

FIG. 2 is a perspective view showing one example of array of driving electrodes and sensing electrodes making up a touch sensor;

FIG. 3A is an explanatory view for describing a state where touch operation is not performed with respect to a schematic configuration and an equivalent circuit of the touch sensor;

FIG. 3B is an explanatory view for describing a state where the touch operation is performed with respect to the schematic configuration and the equivalent circuit of the touch sensor;

FIG. 4 is an explanatory view showing change in a detection signal when the touch operation is not performed and when the touch operation is performed;

FIG. 5 is a schematic view showing an array structure of scanning signal lines of a liquid crystal panel and an array structure of the driving electrodes and the sensing electrodes of the touch sensor;

FIG. 6A is an explanatory view showing one example of a relationship between input of the scanning signal to line blocks of the scanning signal lines performing display update of the liquid crystal panel, and supply of a driving signal to the line blocks of the driving electrodes to perform touch detection of the touch sensor;

FIG. 6B is an explanatory view showing one example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 6C is an explanatory view showing one example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 6D is an explanatory view showing one example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 6E is an explanatory view showing one example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 6F is an explanatory view showing one example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 7A is an explanatory view showing another example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 7B is an explanatory view showing another example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 7C is an explanatory view showing another example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 7D is an explanatory view showing another example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 7E is an explanatory view showing another example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 7F is an explanatory view showing another example of the relationship between the input of the scanning signal to the line blocks of the scanning signal lines performing the display update of the liquid crystal panel, and the supply of the driving signal to the line blocks of the driving electrodes to perform the touch detection of the touch sensor;

FIG. 8 is a timing chart showing an application state of the scanning signal and the driving signal in one horizontal scanning period in the examples shown in FIGS. 6A to 6F;

FIG. 9 is a timing chart for describing one example of a relationship between a display update period and a touch detection period in one horizontal scanning period;

FIG. 10 is a timing chart for describing another example of the relationship between the display update period and the touch detection period in one horizontal scanning period;

FIG. 11 is a timing chart for describing multiple-speed driving to provide a plurality of touch detection periods in one frame period in a driving method of the touch sensor in the present disclosure;

FIG. 12 is an explanatory view for describing timing in a relationship between the supply of the scanning signal to the line blocks of the scanning signal lines and the supply of the driving signal to the line blocks of the driving electrodes with respect to the timing chart shown in FIG. 11;

FIG. 13 is an explanatory view for describing another example of the timing in the relationship between the supply of the scanning signal to the line blocks of the scanning signal lines and the supply of the driving signal to the line blocks of the driving electrodes in the driving method of the touch sensor in the present disclosure;

FIG. 14 is an explanatory view for describing another example of the timing in the relationship between the supply of the scanning signal to the line blocks of the scanning signal lines and the supply of the driving signal to the line blocks of the driving electrodes in the driving method of the touch sensor in the present disclosure;

FIG. 15 is an explanatory view for describing another example of the timing in the relationship between the supply of the scanning signal to the line blocks of the scanning signal lines and the supply of the driving signal to the line blocks of the driving electrodes in the driving method of the touch sensor in the present disclosure; and

FIG. 16 is an explanatory view for describing another example of the timing in the relationship between the supply of the scanning signal to the line blocks of the scanning signal lines and the supply of the driving signal to the line blocks of the driving electrodes in the driving method of the touch sensor in the present disclosure.

### DETAILED DESCRIPTION

Hereinafter, as one example of an input device according to one exemplary embodiment of the present disclosure, taking a touch sensor for use in a liquid crystal display device as an example, a description will be given with reference to the drawings. However, the present disclosure is not limited to this. More detailed description than necessary may be omitted. For example, a detailed description of a well-known item and a redundant description of the substantially same configuration may be omitted. This is intended to avoid making the following description unnecessarily redundant, and facilitate understanding of those in the art.

The inventor et al. provide the accompanying drawings and the following description in order to help those in the art to understand the present disclosure sufficiently, and are not intended to limit the subject described in claims.

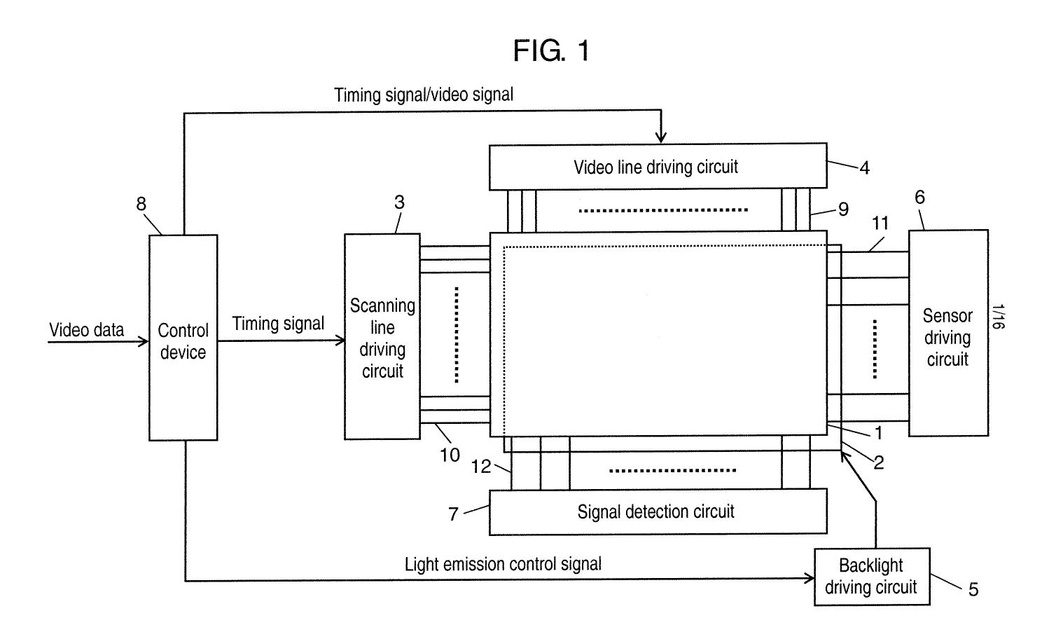

FIG. 1 is a block diagram for describing an entire configuration of a liquid crystal display device having a touch sensor function according to one exemplary embodiment of the present disclosure. As illustrated in FIG. 1, the liquid crystal device includes liquid crystal panel 1, backlight unit 2, scanning line driving circuit 3, video line driving circuit 4, backlight driving circuit 5, sensor driving circuit 6, signal detection circuit 7, and control device 8.

Liquid crystal panel 1 has a rectangular plate shape, and has a TFT (Thin Film Transistor) substrate made of a transparent substrate such as a glass substrate, and an opposed substrate arranged with a predetermined clearance so as to be opposed to this TFT substrate, so that a liquid crystal material is enclosed between the TFT substrate and the opposed substrate.

The TFT substrate is located on a back surface side of liquid crystal panel 1, and is configured by forming pixel electrodes arranged in matrix, thin film transistors (TFTs) as switching elements provided corresponding to the pixel electrodes to control On/Off of voltage application to the pixel electrodes, a common electrode and the like in a substrate making up the TFT substrate.

Moreover, the opposed substrate is located on a front surface side of liquid crystal panel 1, and is formed with a color filter (CF) in at least three primary colors of red (R), green (G), and blue (B) at positions corresponding to the pixel electrodes, a black matrix made of a light shielding material to enhance contrast and the like, the black matrix being arranged between subpixels of RGB and/or the pixels made up of the subpixels. In the present exemplary embodiment, the TFT formed in each of the pixels of the TFT substrate will be described after defining a drain electrode and a source electrode, taking an n-channel TFT as an example.

In the TFT substrate, a plurality of video signal lines 9 and a plurality of scanning signal lines 10 are formed roughly perpendicularly to one another. Each of scanning signal lines 10 is provided in a horizontal row of the TFTs, and is commonly connected to gates of a plurality of TFTs in the horizontal row. Each of video signal lines 9 is provided in a vertical row of the TFTs, and is commonly connected to the drain electrodes of the plurality of TFTs in the vertical row. Moreover, the pixel electrodes arranged in pixel areas corresponding to the TFTs are connected to the source electrodes of the respective TFTs.

On/Off operation of each of the TFTs formed in the TFT substrate is controlled on a horizontal row basis in response to a scanning signal applied to scanning signal lines 10. Each of the TFTs in the horizontal row, which is brought into an On state, sets the pixel electrode to a potential (pixel voltage) in response to a video signal applied to video signal line 9. Liquid crystal panel 1 has a plurality of pixel electrodes and the common electrode provided so as to be opposed to these pixel electrodes, and controls orientation of liquid crystal for each pixel area by an electric field generated between the pixel electrodes and the common electrode to change transmittance to incident light from backlight unit 2, by which an image is formed on a display surface.

Backlight unit 2 is arranged on a rear surface side of liquid crystal panel 1 to apply light from a rear surface of liquid crystal panel 1. There have been known backlight units having, for example, a structure in which a plurality of light-emitting diodes are arrayed to make up a surface light source, and a structure in which light of light-emitting diodes is used by combining a light-guiding plate and a diffuse reflecting plate to make up a surface light source.

Scanning line driving circuit 3 is connected to the plurality of scanning signal lines 10 formed in the TFT substrate. Scanning line driving circuit 3 selects scanning signal line 10 in order in response to a timing signal input from control device 8, and applies a voltage that turns on the TFTs to selected scanning signal line 10. For example, scanning line driving circuit 3 includes a shift resistor, and the shift resistor starts operation upon receiving a trigger signal from control device 8, and sequentially selects scanning signal line 10 in an order along a vertical scanning direction to output a scanning pulse to selected scanning signal line 10.

Video line driving circuit 4 is connected to the plurality of video signal lines 9 formed in the TFT substrate. Video line driving circuit 4 applies a voltage in response to the video signal representing a gradation value of each of the pixels to each of the TFTs connected to selected scanning signal line 10 in accordance with the selection of scanning signal line 10 by scanning line driving circuit 3. This allows the video signal to be written in the pixels corresponding to selected scanning signal line 10. This corresponds to horizontal scanning of a raster image. This operation of video line driving circuit 4 corresponds to vertical scanning.

Backlight driving circuit 5 allows backlight unit 2 to emit light at timing and brightness in response to a light emission control signal input from control device 8.

In liquid crystal panel 1, a plurality of driving electrodes 11 and a plurality of sensing electrodes 12 are arranged as electrodes making up a touch sensor so as to intersect with one another.

In the present exemplary embodiment, driving electrodes 11 are formed in an electrically insulated state around the pixel electrodes of the TFT substrate so as to extend in a line direction (horizontal direction) of pixel array. Sensing electrodes 12 are formed at positions corresponding to the black matrix of the opposed substrate so as to extend in a row direction (vertical direction) of the pixel array. Moreover, as another example of the configuration of the plurality of driving electrodes 11 and the plurality of sensing electrodes 12, the configuration may be such that the common electrode formed in the TFT substrate is divided to thereby be shared as the plurality of driving electrodes 11, and that the plurality of sensing electrodes 12 are formed in an electrically insulated state around the pixel electrodes of the TFT substrate.

The touch sensor made up of driving electrodes 11 and sensing electrodes 12 performs input and response detection of electric signals between driving electrodes 11 and sensing electrodes 12 to detect contact of an object to the display surface. As electric circuits that detect this contact, sensor driving circuit 6 and signal detection circuit 7 are provided.

Sensor driving circuit 6 is an alternating current (AC) signal source, and is connected to driving electrodes 11. For example, a timing signal is input to sensor driving circuit 6 from control device 8, and driving electrodes 11 are selected in order in synchronization with image display of liquid crystal panel 1 to supply driving signal Txv by a rectangular pulse voltage to selected driving electrode 11. For example, sensor driving circuit 6 includes a shift resistor as with scanning line driving circuit 3, and operates the shift resistor upon receiving a trigger signal from control device 8 to sequentially select driving electrodes 11 in an order along the vertical scanning direction, and supply driving signal Txv by the pulse voltage to selected driving electrode 11.

Driving electrodes 11 and scanning signal lines 10 are formed so as to extend in the row direction in the horizontal direction in the TFT substrate, and the plurality of driving electrodes 11 and the plurality of scanning signal lines 10 are arrayed in the line direction in the vertical direction. Sensor driving circuit 6 and scanning driving circuit 3 electrically connected to driving electrodes 11 and scanning signal lines 10 are desirably arranged along vertical sides in a display area where the pixels are arrayed. Scanning line driving circuit 3 is arranged in one of the right and left vertical sides, while sensor driving circuit 6 is arranged on the other side.

Signal detection circuit 7 is a detection circuit that detects capacitance change, and is connected to sensing electrodes 12. In signal detection circuit 7, a detection circuit is provided for each sensing electrode 12, and a voltage of each of sensing electrodes 12 is detected as detection signal Rxv. As another configuration example, one detection circuit may be provided in a group of the plurality of sensing electrodes 12, and may perform voltage monitoring of the plurality of sensing electrodes 12 in time division within persistence time of the pulse voltage applied to driving electrodes 11 to detect detection signal Rxv.

A contact position of an object on the display surface is found, based on to which driving electrode 11 driving signal Txv is applied and in which sensing electrode 12 the voltage at the time of contact is detected. An intersection point between driving electrode 11 and sensing electrode 12 is found as the contact position by a mathematic operation. As a mathematic operation method for finding the contact position, there are a method of performing the mathematic operation by providing a mathematic operation circuit in the liquid crystal display device, and a method of performing the mathematic operation by a mathematic operation circuit outside the liquid crystal display device.

Control device 8 includes a mathematic operation processing circuit such as a CPU (Central Processing Unit), and a memory such as a ROM (Read-Only Memory) and a RAM (Random-Access Memory). Based on input video data, control device 8 performs various types of image signal processing such as color adjustment to generate an image signal representing the gradation value of each of the pixels and supply the image signal to video line driving circuit 4. Moreover, based on the input video data, control device 8 generates timing signals to synchronize operations of scanning line driving circuit 3, video line driving circuit 4, backlight driving circuit 5, sensor driving circuit 6, and signal detection circuit 7 to supply the same to these circuits. Also, control device 8 supplies a brightness signal to control brightness of the light-emitting diodes, based on the input video data, as the light emission control signal to backlight driving circuit 5.

Here, scanning line driving circuit 3, video line driving circuit 4, sensor driving circuit 6, and signal detection circuit 7 connected to the respective signal lines and the respective electrodes of liquid crystal panel 1 are each configured by mounting a semiconductor chip of each of the circuits on a flexible wiring board or a printed wiring board. However, scanning line driving circuit 3, video line driving circuit 4, and sensor driving circuit 6 may be formed on the TFT substrate at the same time with TFTs and the like to thereby be mounted.

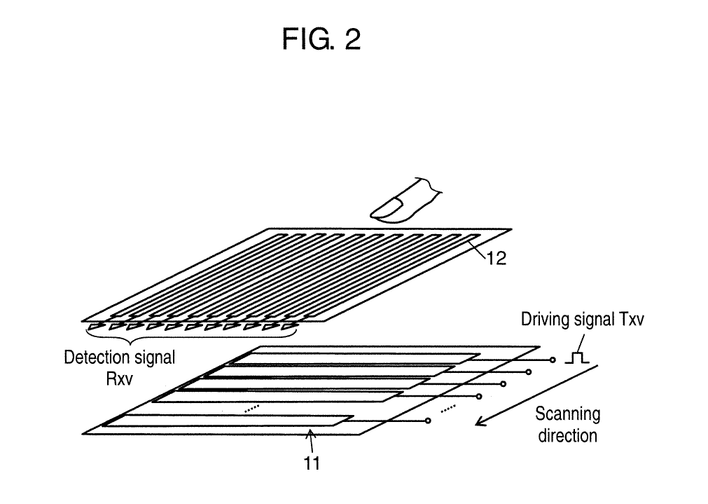

FIG. 2 is a perspective view showing one example of array of the driving electrodes and the sensing electrodes making up the touch sensor. As shown in FIG. 2, the touch sensor as the input device is made up of driving electrodes 11, which are a plurality of stripe-shaped electrode patterns extending in a right-left direction in FIG. 2, and sensing electrodes 12, which are the plurality of stripe-shaped electrode patterns extending in a direction intersecting with the extending direction of the electrode patterns of driving electrodes 11. A capacitive element having a capacitance is formed at each of intersection portions where respective driving electrodes 11 and sensing electrodes 12 intersect.

Moreover, driving electrodes 11 are arrayed so as to extend in the direction parallel to the direction where scanning signal lines 10 extend. If the M (M is a natural number) scanning signal lines make up one line block, driving electrode 11 is arranged, corresponding to each of the plurality of N (N is a natural number) line blocks, so that the driving signal is applied to each of the line blocks. A detailed description will be given later.

When touch detection operation is performed, driving signal Txv is supplied from sensor driving circuit 6 to driving electrodes 11 to perform line-sequential scanning in time division on a line block basis, by which the one line block as a detection object is sequentially selected. Moreover, detection signal Rxv is output from sensing electrodes 12, by which touch detection of the one line block is performed.

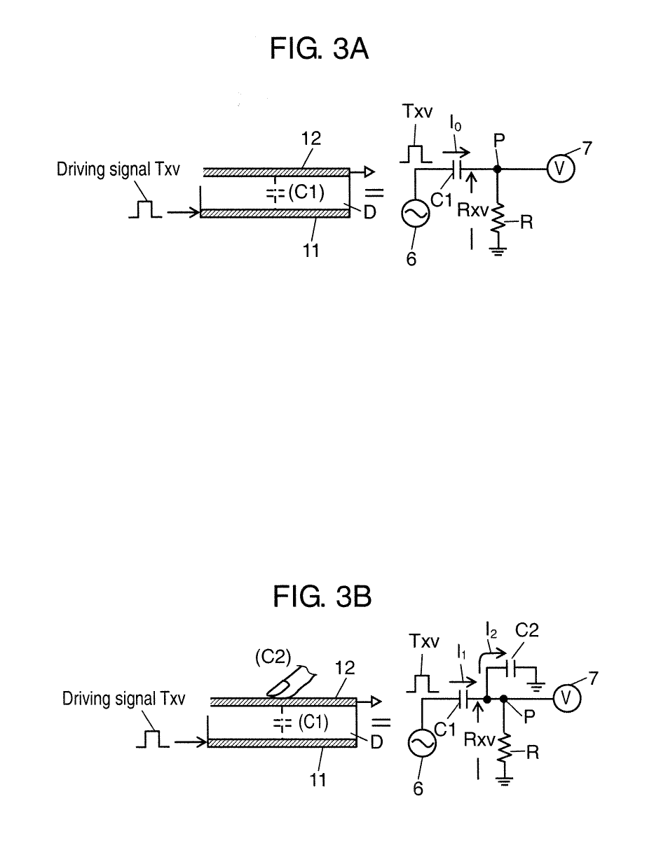

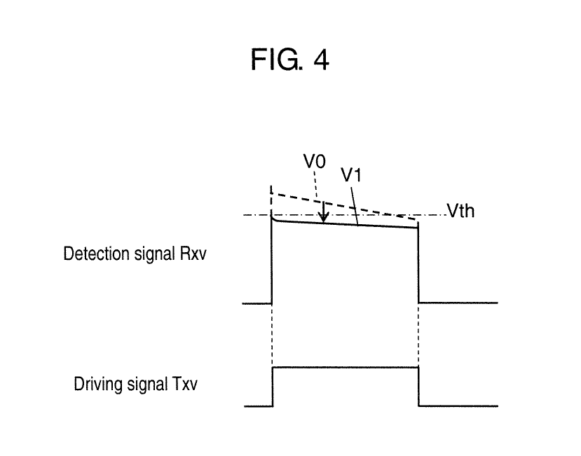

Next, a principle of the touch detection in a capacitive touch sensor will be described with reference to FIGS. 3A, 3B, and 4.

FIGS. 3A and 3B are explanatory views for describing a state where touch operation is not performed (FIG. 3A), and a state where touch operation is performed (FIG. 3B) with respect to a schematic configuration and an equivalent circuit of the touch sensor. FIG. 4 is an explanatory view showing change in the detection signal when the touch operation is not performed and when the touch operation is performed, as shown in FIGS. 3A and 3B.

As shown in FIG. 2, in the capacitive touch sensor, at an intersection part between a pair of driving electrode 11 and sensing electrode 12 arranged in matrix so as to intersect with each other, driving electrode 11 and sensing electrode 12 are arranged so as to be opposed with dielectric body D interposed, which configures a capacitive element. The equivalent circuit is represented as shown in FIG. 3A, and driving electrode 11, sensing electrode 12 and dielectric body D make up capacitive element C1. One end of capacitive element C1 is connected to sensor driving circuit 6 as the AC signal source, and another end P is grounded through resistor R and is connected to signal detection circuit 7 as a voltage detector.

When driving signal Txv (FIG. 4) by the pulse voltage of a predetermined frequency of about several kHz to ten and several kHz is applied to driving electrode 11 (the one end of capacitive element C1) from sensor driving circuit 6 as the AC signal source, an output waveform (detection signal Rxv) as shown in FIG. 4 appears in sensing electrode 12 (other end P of capacitive element C1).

In a state where a finger is not in contact (or close), as shown in FIG. 3A, current I0 in response to a capacitance value of capacitive element C1 flows with charging/discharging with respect to capacitive element C1. A potential waveform at other end P of capacitive element C1 at this time becomes waveform V0 in FIG. 4, which is detected by signal detection circuit 7 as the voltage detector.

On the other hand, in a state where the finger is in contact (or close), as shown in FIG. 3B, the equivalent circuit has a form in which capacitive element C2 formed by the finger is added to capacitive element C1 in series. In this state, currents I1, I2 flow with charging/discharging with respect to capacitive elements C1, C2, respectively. The potential waveform at other end P of capacitive element C1 at this time becomes waveform V1 in FIG. 4, which is detected by signal detection circuit 7 as the voltage detector. At this time, a potential at point P is a divided potential determined by values of currents I1, I2 flowing capacitive elements C1, C2. This makes a value of waveform V1 smaller than that of waveform V0 in the non-contact state.

Signal detection circuit 7 compares the potential of the detection signal output from each of sensing electrodes 12 with predetermined threshold voltage Vth, and if the potential of the detection signal is this threshold voltage or higher, the non-contact state is determined, and if the potential is lower than the threshold voltage, the contact state is determined. In this manner, the touch detection is enabled. Beside this method, as a method for detecting the signal of change in capacitance, there are a method of detecting change in current, and the like.

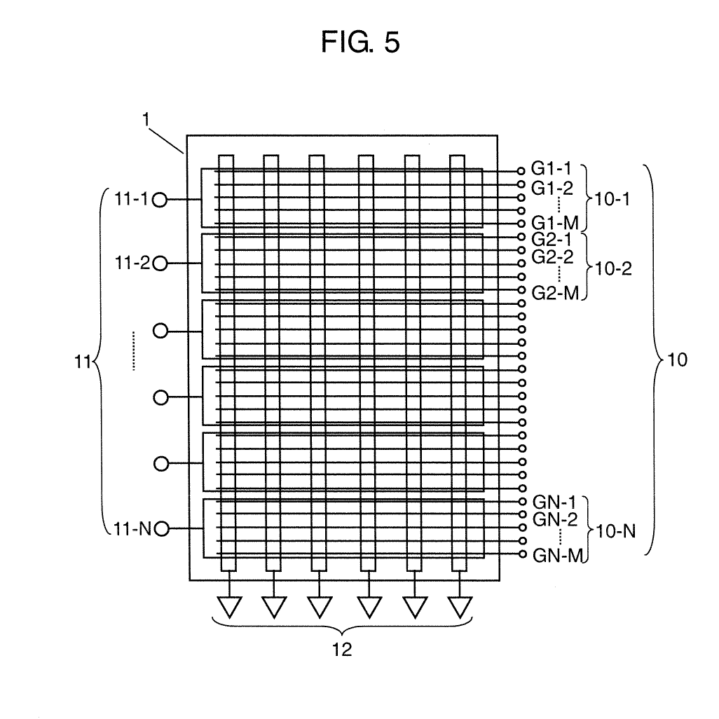

Next, one example of a method for driving the touch sensor according to the present disclosure will be described with reference to FIGS. 5 to 17.

FIG. 5 is a schematic view showing an array structure of the scanning signal lines of the liquid crystal panel and an array structure of the driving electrodes and the sensing electrodes of the touch sensor. As shown in FIG. 5, as to the plurality of scanning signal lines 10 extending in the horizontal direction, M (M is a natural number) scanning signal lines G1-1, G1-2, . . . , G1-M make up one line block, and scanning signal lines 10 are divided into the plurality of N (N is a natural number) line blocks 10-1, 10-2, . . . , 10-N to be arrayed.

As for driving electrodes 11 of the touch sensor, driving electrodes 11-1, 11-2, . . . , 11-N in quantity of N are arrayed so as to extend in the horizontal direction, corresponding to line blocks 10-1, 10-2, . . . , 10-N, and the plurality of sensing electrodes 12 are arrayed so as to intersect with driving electrodes 11-1, 11-2, . . . , 11-N in quantity of N.

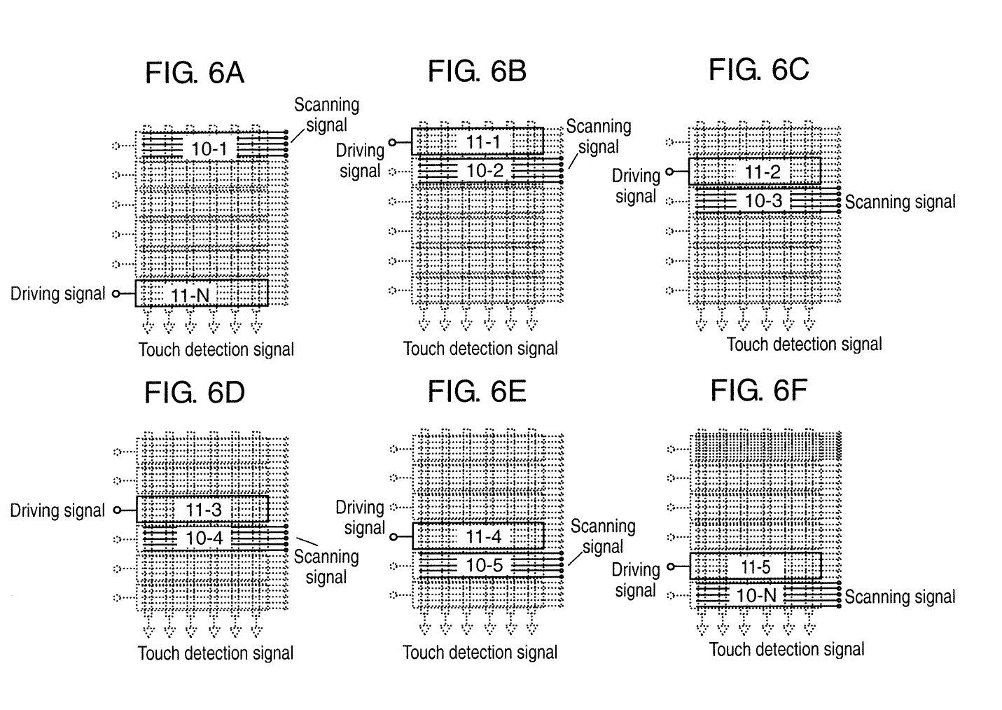

FIGS. 6A to 6F are explanatory views showing one example of a relationship between input of the scanning signal to the line blocks of the scanning signal lines performing display update of the liquid crystal panel, and the supply of the driving signal to the line blocks of the driving electrodes to perform the touch detection of the touch sensor. Each of FIGS. 6A to 6F shows a state in one line block scanning period.

As shown in FIG. 6A, in a horizontal scanning period when the scanning signal is sequentially input to each of the scanning signal lines of first line block 10-1 which is a top line, the driving signal is supplied to driving electrode 11-N corresponding to last line block 10-N which is a bottom line. In a subsequent horizontal scanning period, that is, as shown in FIG. 6B, in a horizontal scanning period when the scanning signal is sequentially input to each of the scanning signal lines of second line block 10-2 from top, the driving signal is supplied to driving electrode 11-1 corresponding to first line block 10-1 one line before.

As shown in FIGS. 6C to 6F, as the horizontal scanning periods when the scanning signal is sequentially input to each of the scanning signal lines of line blocks 10-3, 10-4, 10-5, . . . , 10-N are sequentially proceeding, the driving signal is supplied to driving electrodes 11-2, 11-3, 11-4, 11-5 corresponding to line blocks 10-2, 10-3, 10-4, 10-5 one line before.

That is, in the present disclosure, the supply of the driving signal to the plurality of driving electrodes 11 is configured such that the driving electrode corresponding to the line block where the scanning signal is not applied to the plurality of scanning signal lines is selected to supply the driving signal in the scanning period of the one line block performing the display update.

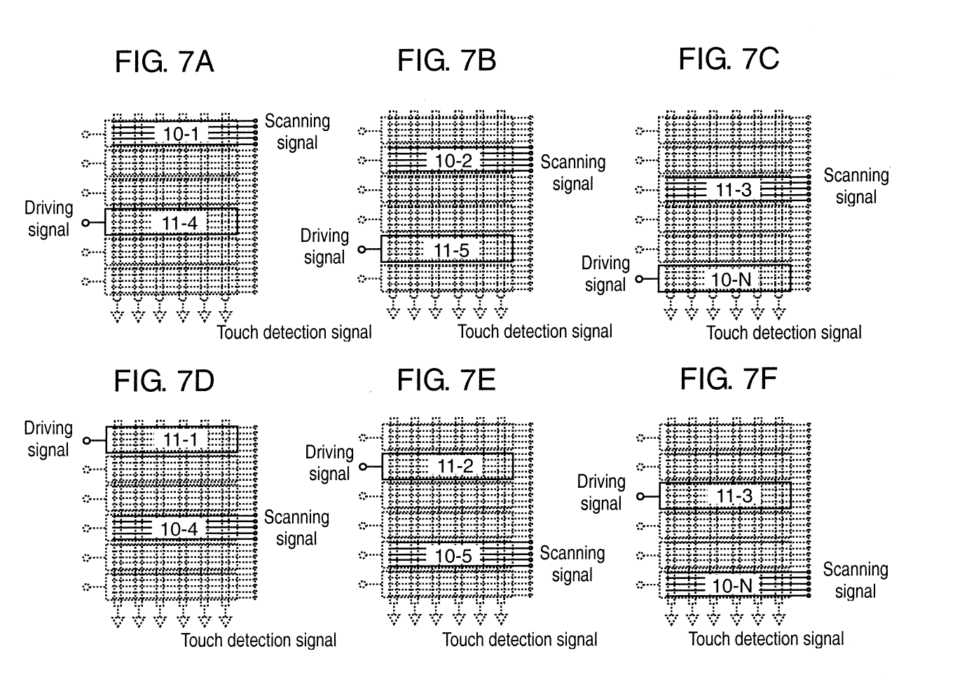

FIGS. 7A to 7F are explanatory views showing another example of the relationship between the input of the scanning signal to the line blocks of the scanning signal lines performing display update of the liquid crystal panel, and the supply of the driving signal to the line blocks of the driving electrodes to perform the touch detection of the touch sensor.

The example shown in FIGS. 6A to 6F is configured so that the driving signal is supplied to the driving electrodes corresponding to the line block one line before the line block of the scanning signal lines to which the scanning signal is input. The example shown in FIGS. 7A to 7F is configured so that the driving electrode to which the driving signal is supplied is not limited to the line block one line before, but the driving electrode corresponding to an arbitrary line block where the scanning signal is not applied to the plurality of scanning signal lines is selected to supply the driving signal in the one horizontal scanning period when the display update is performed.

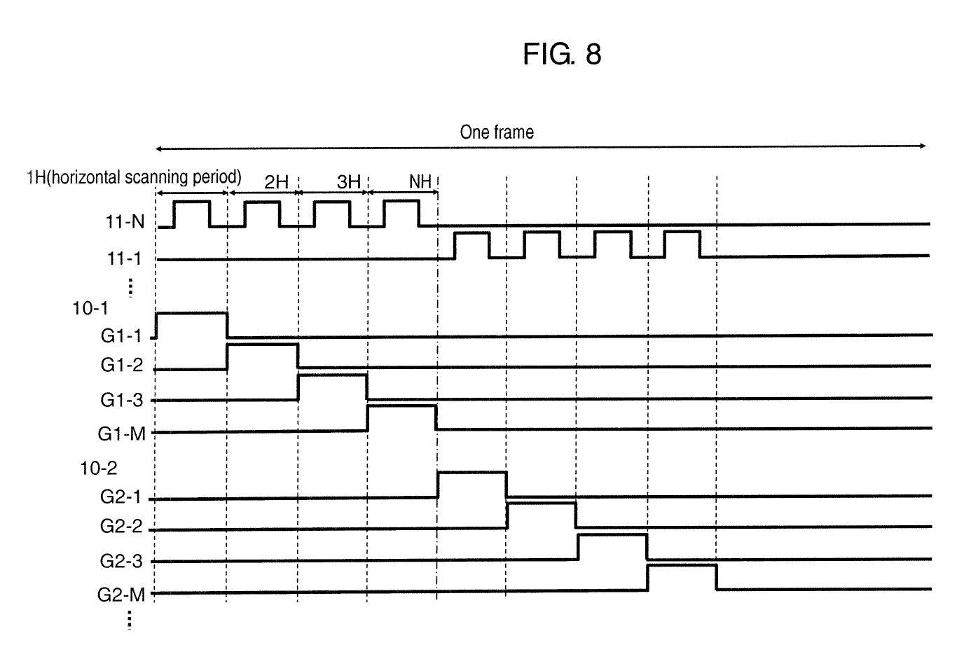

FIG. 8 is a timing chart showing an application state of the scanning signal and the driving signal in one horizontal scanning period in the example shown in FIGS. 6A to 6F. As shown in FIG. 8, in each of horizontal scanning periods (1H, 2H, 3H, . . . , NH) in one frame period, the scanning signal is input to scanning signal lines 10 on a line block basis (10-1, 10-2, . . . , 10-N) to perform display update. Within these periods when the scanning signal is input, the driving signal for the touch detection is supplied to driving electrodes 11-1, 11-2, . . . , 11-N corresponding to the line blocks of the scanning signal lines.

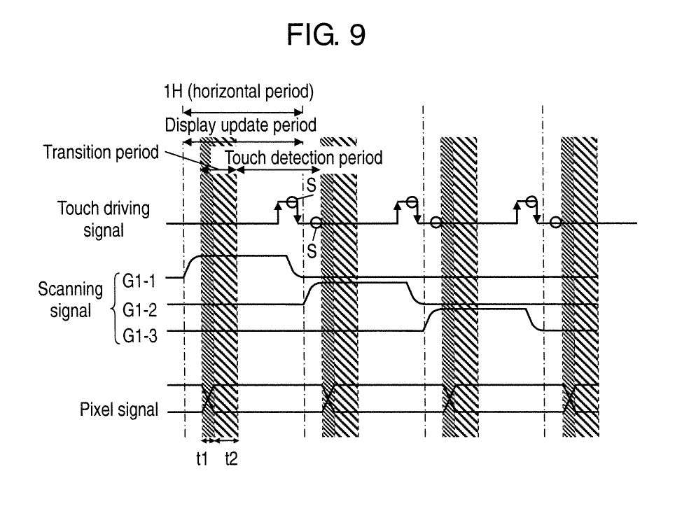

FIG. 9 is a timing chart for describing one example of a relationship between a display update period and a touch detection period in one horizontal scanning period.

As shown in FIG. 9, in the display update period, the scanning signal is sequentially input to scanning signal lines 10, and a pixel signal in response to the input video signal is input to video signal lines 9 connected to the switching elements of the pixel electrodes of the pixels. In FIG. 9, before and after each of the horizontal scanning periods, there exist transition periods corresponding to time required for rise of the pulsed scanning signal to a predetermined potential and time required for fall of the pulsed scanning signal to a predetermined potential.

In the present disclosure, the touch detection period is provided at the same timing as this display update period, and the touch detection period is defined as a period excluding the transition period from the display update period. That is, at a time point when the transition period when the scanning signal rises to the predetermined potential almost ends, the pulse voltage is supplied to driving electrode 11 as the driving signal, and the touch detection period starts at a displacement point of the potential by the rise of the pulse voltage. Moreover, touch detection timing S exists at two points, that is, immediately before the fall point of the pulse voltage and at an end point of the touch detection period. Here, for the transition period, period t1 of a first half when the pixel signal is displaced and period t2 when a potential of the common electrode is displaced with the displacement of the pixel signal are set. This is because even after a transition period of the pixel signal, the potential of the common electrode fluctuates due to capacitive coupling of parasitic capacitance inside the panel, and this period is considered to be the transition period as well, so that the touch detection period excludes this period.

The touch detection operation in this touch detection period is as described with reference to FIGS. 3A, 3B, and 4.

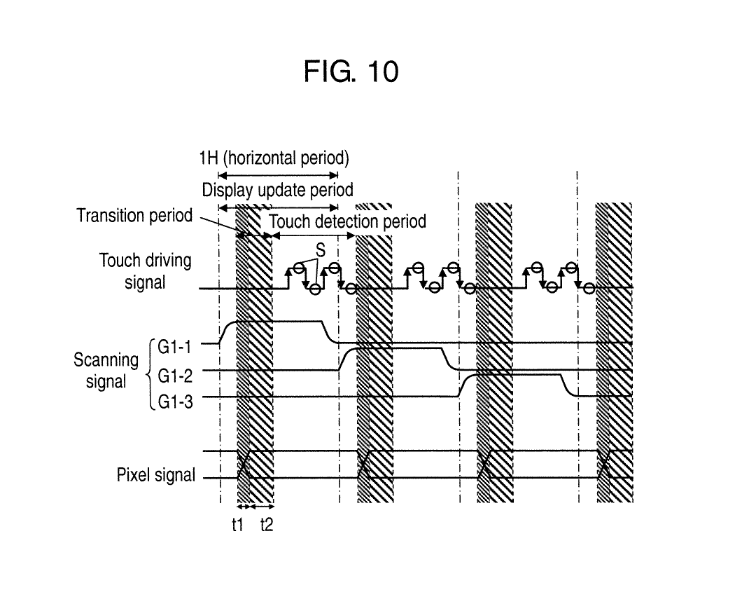

FIG. 10 is a timing chart for describing another example of the relationship between the display update period and the touch detection period in one horizontal scanning period. In an example shown in FIG. 10, a plurality of (two in the illustration) pulses are applied as the driving signal supplied in the touch detection period within the horizontal scanning period.

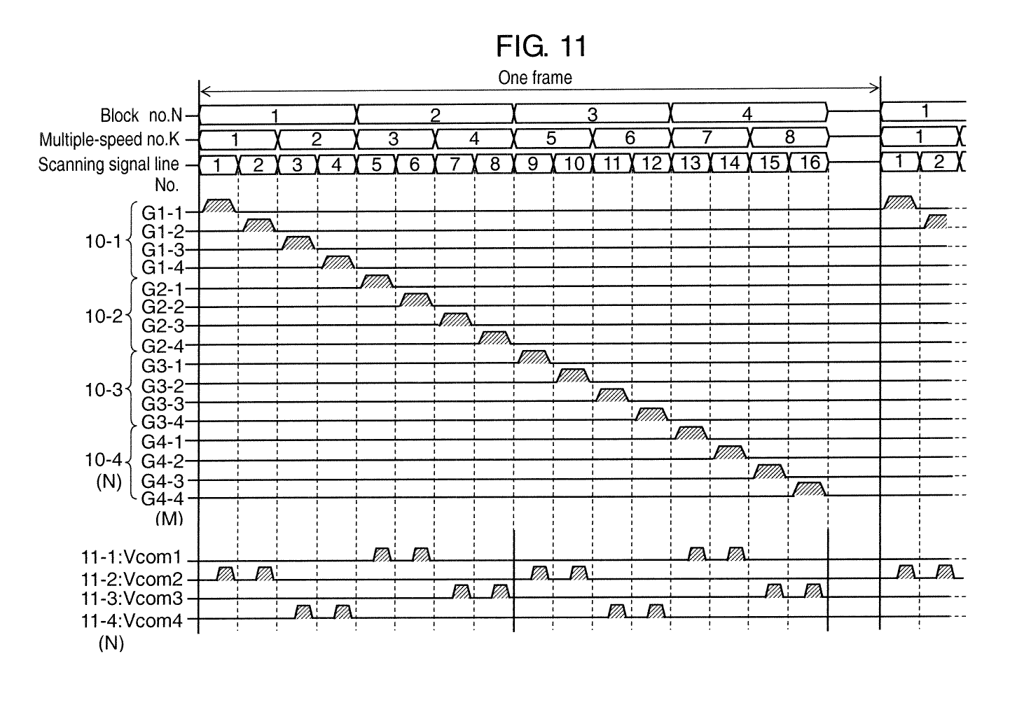

FIGS. 11 to 16 are timing charts for describing multiple-speed driving to provide the plurality of touch detection periods within one frame period in the method for driving the touch sensor in the present disclosure.

FIG. 11 shows one example of a timing chart in which the M (M is a natural number) scanning signal lines make up one line block, and in an input device of a display device having X (M×N) scanning signal lines, which are divided into the plurality of N (N is a natural number) line blocks, the touch detection is performed at A-time speed (double speed in the illustration) of a frame period. In the timing chart in FIG. 11, pulses input to scanning signal lines 10, and the driving signal input to driving electrodes 11 in quantity of N are shown, corresponding to a scanning signal line number (M×N), multiple-speed numbers (K), and a block number (N). That is, the touch detection operation performs the multiple-speed driving in which a relationship between touch detection time t1 when the driving signal is input to the driving electrodes in quantity of N, and display update time t2 when the scanning signal is input to the X scanning signal lines is t1<t2.

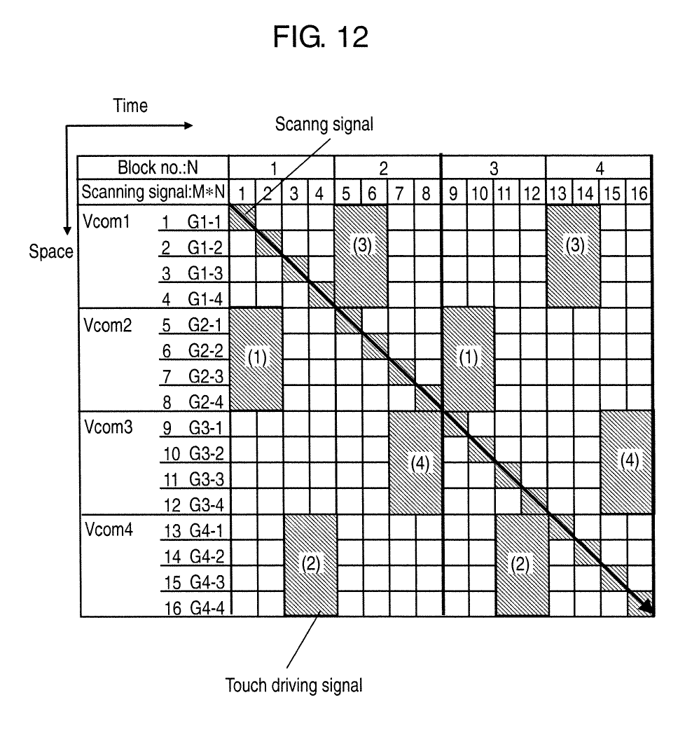

FIG. 12 is an explanatory view for describing timing in a relationship between the supply of the scanning signal to the blocks in quantity of N of the scanning signal lines and the supply of the driving signal to line blocks of the driving electrodes in quantity of N of the touch sensor with respect to the timing chart shown in FIG. 11. In FIG. 12, numbers given to the touch driving signals indicate an order in which the driving signal is input.

In the present disclosure, as described above, in the touch detection period, the driving signal is sequentially applied to the driving electrodes in quantity of N, and the touch detection is performed, based on the detection signal output from each of the plurality of sensing electrodes. As shown in FIGS. 11 and 12, when input timing of the scanning signal to the M scanning signal lines is Ts, input operation of the driving signal to the driving electrodes in quantity of N is configured such that the input of the driving signal starts from the Nx-th (a numerical value obtained by adding an integer of one or more to the first driving electrode) driving electrode at input timing Ty (a numerical value obtained by adding an integer of 0 or more to Ts), and the driving electrode that does not correspond to the scanning signal line to which the scanning signal is being input is selected to input the driving signal. Moreover, the input operation of the driving signal for the touch detection is configured such that the driving electrodes in quantity of N are divided into a plurality of blocks, and in the respective blocks, the block of the driving electrodes that does not correspond to the scanning signal line to which the scanning signal is being input is selected to input the driving signal.

Moreover, as shown in FIGS. 11 and 12, the input operation of the driving signal for the touch detection has interlaced scanning input sections in which the driving signal is input by interlacing on a block basis, as indicated by an order (1), (2), (3), (4) in an array direction of the driving electrodes.

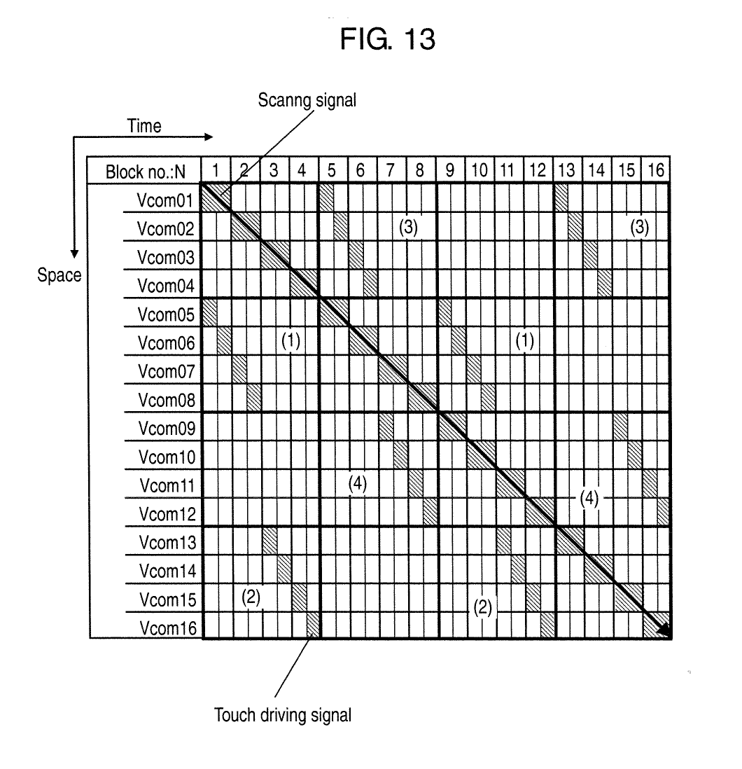

FIG. 13 is an explanatory view of an example different from the example shown in FIG. 12. In the example shown in FIG. 13, the input operation of the driving signal for the touch detection has sequential input sections in which the driving signal is sequentially input in the array direction of driving electrodes 11, and interlaced scanning input sections in which the driving signal is input by interlacing on a block basis, as indicated by the order (1), (2), (3), (4) in the array direction of the driving electrodes.

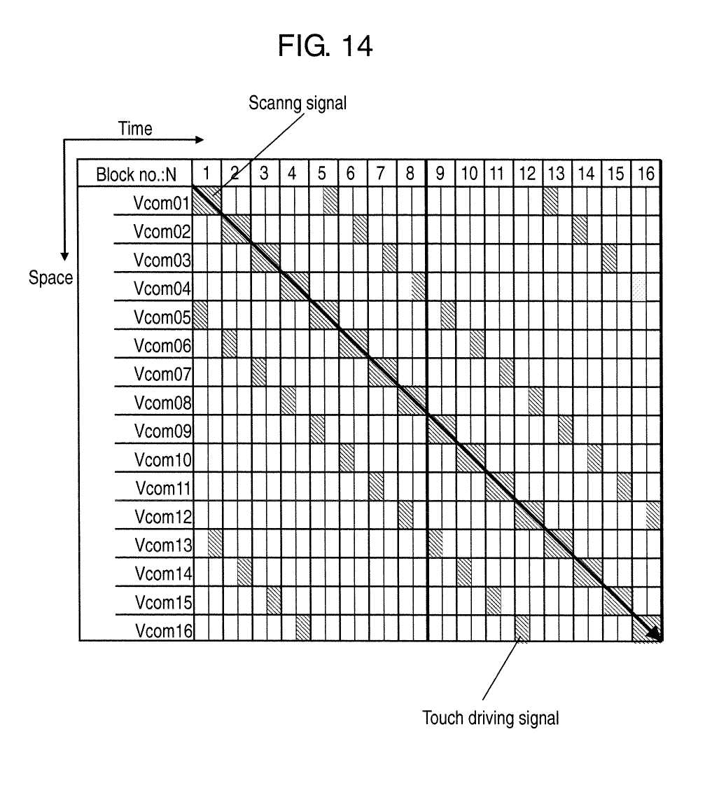

FIG. 14 is an explanatory view of an example different from the examples shown in FIGS. 12 and 13. In the example shown in FIG. 14, the input operation of the driving signal for the touch detection has interlaced scanning input sections in which the driving signal is input by interlacing in the array direction of driving electrodes 11. That is, when the input timing of the scanning signal to the plurality of scanning signal lines is Ts, the input operation of the driving signal to the driving electrodes in quantity of N is configured such that the input of the driving signal starts from the Nx-th (a numerical value obtained by adding an integer of one or more to the first driving electrode) driving electrode at input timing Ty (a numerical value obtained by adding an integer of 0 or more to Ts), and the driving electrode that does not correspond to the scanning signal line to which the scanning signal is being input is selected to input the driving signal by interlacing.

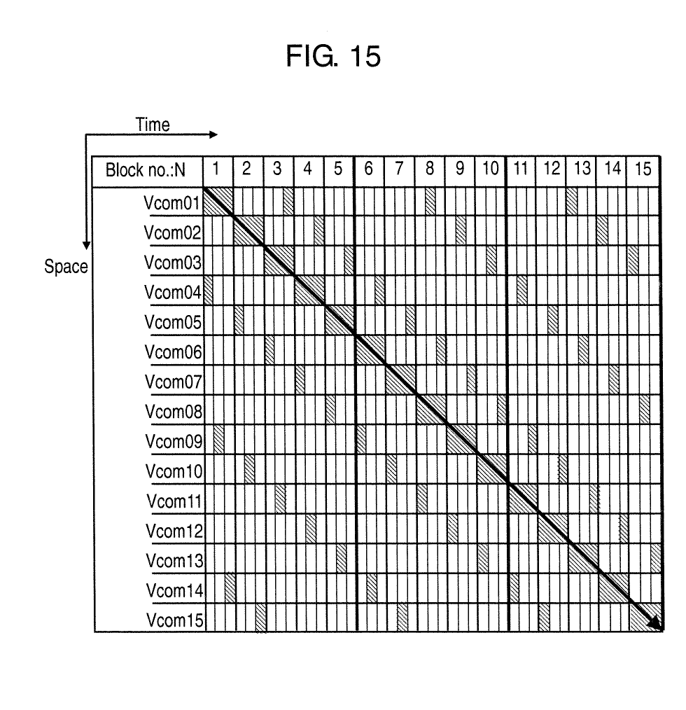

FIG. 15 is an explanatory view showing an example in which the input operation of the driving signal for the touch detection is performed at a three-time speed in the example shown in FIG. 14. In the example shown in FIG. 15 as well, when the input timing of the scanning signal to the plurality of scanning signal lines is Ts, the input operation of the driving signal to the driving electrodes in quantity of N is configured such that the input of the driving signal starts from the Nx-th (a numerical value obtained by adding an integer of one or more to the first driving electrode) driving electrode at input timing Ty (a numerical value obtained by adding an integer of 0 or more to Ts), and the driving electrode that does not correspond to the scanning signal line to which the scanning signal is being input is selected to input the driving signal by interlacing.

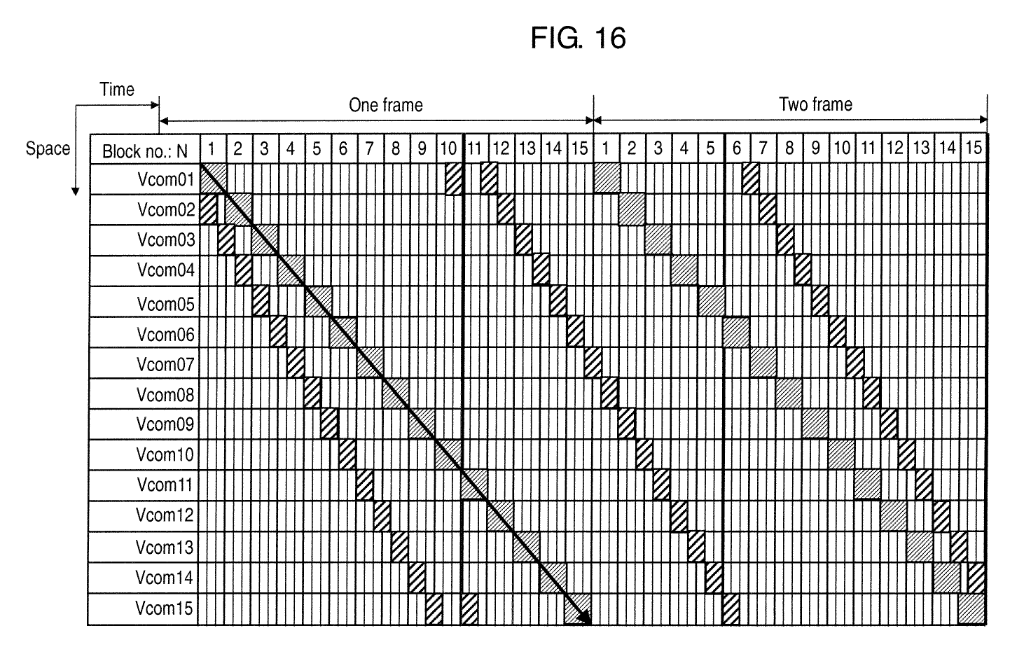

FIG. 16 is an explanatory view showing an example in which the input operation of the driving signal for the touch detection is performed at a 1.5-time speed. In the example shown in FIG. 16, when the input timing of the scanning signal to the plurality of scanning signal lines is Ts, the input operation of the driving signal to the driving electrodes in quantity of N is configured such that the input of the driving signal starts from the Nx-th (a numerical value obtained by adding an integer of one or more to the first driving electrode) driving electrode at input timing Ty (a numerical value obtained by adding an integer of 0 or more to Ts), and the driving electrode that does not correspond to the scanning signal line to which the scanning signal is being input is selected to sequentially perform scanning and input the driving signal.

As described above, in the input device according to the present disclosure, in the touch detection period, the driving signal is sequentially applied to the driving electrodes in quantity of N, and the touch detection is performed by the detection signal output from each of the plurality of sensing electrodes. When the input timing of the scanning signal to the plurality of scanning signal lines is Ts, the input operation of the driving signal to the driving electrodes in quantity of N is configured such that the input of the driving signal starts from the Nx-th (a numerical value obtained by adding an integer of one or more to the first driving electrode) driving electrode at input timing Ty (a numerical value obtained by adding an integer of 0 or more to Ts), and the driving electrode that does not correspond to the scanning signal line to which the scanning signal is being input is selected to input the driving signal.

This can reduce noise occurrence by the scanning signal to perform the display update during the touch detection to increase detection accuracy. In addition, since the touch detection is performed within the display update period, writing time for the display update can be sufficiently assured, and deterioration in display quality can be prevented.

As described above, as illustrations of the technique in the present disclosure, the exemplary embodiments have been described. For these, the accompanying drawings and detailed description have been provided.

Accordingly, the components described in the accompanying drawings and the detailed description may include not only essential components for solving the problems but unessential components for solving the problems in order to illustrate the above-described technique. It should not be recognized that unessential components are essential because the unessential components have been illustrated in the accompanying drawings and described in the detailed description.

Moreover, the above-described exemplary embodiments are to illustrate the technique in the present disclosure, and thus, various modifications, replacements, additions, omissions and the like can be performed in the scope of claims or in a scope equivalent thereto.

What is claimed is:

1. An input device arranged in a display device that sequentially applies a scanning signal to a plurality of scanning signal lines in one frame period to perform update of display, the input device comprising:
driving electrodes in quantity of N provided corresponding to the plurality of scanning signal lines; and
a plurality of sensing electrodes arranged so as to intersect with the driving electrodes in quantity of N to form capacitive elements at intersection portions,
wherein in a touch detection period, a driving signal is sequentially applied to the driving electrodes in quantity of N, and a touch detection is performed based on a detection signal output from each of the plurality of sensing electrodes, and
the scanning signal is input to the scanning signal lines at a timing of Ts, then an input operation of the driving signal to the driving electrodes in quantity of N is configured such that the input of the driving signal starts from an Nx-th (a numerical value obtained by adding an integer of one or more to a first driving electrode) driving electrode at input timing Ty (a numerical value obtained by adding an integer of 0 or more to Ts), and one of the driving electrodes that does not correspond to the scanning signal lines to which the scanning signal is being input is selected to input the driving signal.

2. The input device according to claim 1, wherein the input operation of the driving signal for the touch detection includes interlaced scanning input sections in which the driving signal is input by interlacing in an array direction of the driving electrodes.

3. The input device according to claim 1, wherein the input operation of the driving signal for the touch detection includes sequential input sections in which the driving signal is sequentially input in an array direction of the driving electrodes, and interlaced scanning input sections in which the driving signal is input by interlacing in the array direction of the driving electrodes.

4. The input device according to claim 1, wherein the input operation of the driving signal for the touch detection is configured such that the driving electrodes in quantity of N are divided into a plurality of blocks, and in each one of the blocks, a block of the driving electrodes that do not correspond to the scanning signal line to which the scanning signal is being input is selected to input the driving signal.

5. The input device according to claim 1, wherein a relationship between touch detection time t1 when the driving signal is input to the driving electrodes and display update time t2 when the scanning signal is input to the scanning signal lines is t1<t2.

6. The input device according to claim 1, wherein the touch detection period is provided in a display update period in a horizontal scanning period of the display device.
